(19) United States
(12) Patent Application Publication
(10) Pub. No.: US 2026/0097810 A1
(43) Pub. Date: Apr. 9, 2026

(54) ALL-WHEEL STEER LOADER

(71) Applicant: Doosan Bobcat North America, Inc., West Fargo, ND (US)

(72) Inventors: Michael Schmidt, Bismarck, ND (US); Brent C. Durkin, Bismarck, ND (US); Shane C. Wagner, West Fargo, ND (US); Andrew Hoffman, Bismarck, ND (US); William Jacobson, West Fargo, ND (US); Kenneth L. Dieter, Danvers, MN (US)

(21) Appl. No.: 19/347,408

(22) Filed: Oct. 1, 2025

Related U.S. Application Data
(60) Provisional application No. 63/703,777, filed on Oct. 4, 2024.

(51) Int. Cl. B62D 11/04; B60K 1/02; B60K 17/04; B60K 17/342; B60K 17/356; B62D 3/02; B62D 7/12

(52) U.S. Cl. CPC B62D 11/04; B60K 1/02; B60K 17/043; B60K 17/342; B60K 17/356; B62D 3/02; B62D 7/12

(57) ABSTRACT

A power machine includes a frame, a plurality of wheels, a steering actuator, a hub, a link and a bell crank. The plurality of wheels are in contact with a ground surface that serves as a horizontal reference. The steering actuator is mounted on the frame and is configured for substantially vertical extension and retraction. The hub includes a stationary portion and a rotatable portion, wherein one of the plurality of wheels is mounted on the rotatable portion to pivot about a first axis. The link has a first end pivotally connected to the rotatable portion of the hub. The bell crank comprises first, second and third pivot joints. The first pivot joint is attached to an end of the steering actuator, the second pivot joint is attached to the stationary portion of the hub, and the third pivot joint is attached to a second end of the link.

### CROSS-REFERENCE TO RELATED APPLICATION(S)

This application claims priority to U.S. provisional application number 63/703,777, filed on 4 Oct. 2024, the content of which is hereby incorporated by reference in its entirety.

### BACKGROUND

This disclosure is directed toward power machines. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include excavators, loaders, utility vehicles, tractors, and trenchers, to name a few examples.

Small power machines, such as mini-loaders, can operate in tight areas, pass through narrow openings, and need less storage space. It is also desirable for such smaller power machines to have the capability of lifting significant loads and maneuvering in work environments with limited space.

The discussion above is merely provided for general background information and is not intended to be used as an aid in determining the scope of the claimed subject matter.

### SUMMARY

In one aspect, a power machine comprises a frame, a plurality of wheels, a steering actuator, a hub, a link and a bell crank. The plurality of wheels are in contact with a ground surface that serves as a horizontal reference. The steering actuator is mounted on the frame and is configured for substantially vertical extension and retraction. The hub comprises a stationary portion and a rotatable portion, wherein one of the plurality of wheels is mounted on the rotatable portion to pivot about a first axis with respect to the stationary portion. The link has a first end pivotally connected to the rotatable portion of the hub. The bell crank comprises first, second and third pivot joints. The first pivot joint of the bell crank is attached to an end of the steering actuator, the second pivot joint of the bell crank is attached to the stationary portion of the hub, and the third pivot joint of the bell crank is attached to a second end of the link.

In another aspect, a power machine comprises a drive chain case, two left wheels and two right wheels, a first gear box and a first traction motor. The two left wheels and two right wheels are operably connected to the drive chain case, wherein the two left wheels and two right wheels are in contact with a ground surface that serves as a horizontal reference. The first gear box is mounted on the drive chain case between the two left wheels. The first traction motor is mounted on an upper portion of the gear box and is configured to drive the two left wheels.

In yet another aspect, a power machine comprises a drive chain case, two left wheels and two right wheels, a first traction motor, a first gear reduction and a second gear reduction. The two left wheels and the two right wheels are operably connected to the drive chain case, wherein the two left wheels and the two right wheels are in contact with a ground surface that serves as a horizontal reference. The first traction motor is configured to drive the two left wheels. The first gear reduction is configured to reduce a rotational speed of the first traction motor to a drive chain case speed, wherein the first gear reduction is disposed between the first traction motor and the drive chain case. The second gear reduction is configured to reduce the drive chain case speed, wherein the second gear reduction is disposed between drive chain case and one of the two left wheels.

This summary and the Abstract are provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals, or reference numbers indexed by 100, throughout the several views. All descriptions are applicable to like and analogous structures throughout the several embodiments, unless otherwise specified.

FIG. 1 is a block diagram illustrating functional systems of a representative power machine on which embodiments of the present disclosure can be practiced.

FIG. 2 is a left and rear perspective view of a representative power machine in the form of a wheeled mini-loader of a type on which the disclosed embodiments can be practiced.

FIG. 3 is a top view of the representative power machine (without the primary batteries).

FIG. 4 is a partial left perspective view of an exemplary loader with the front left wheel removed from its hub.

FIG. 5 is a rear perspective view of the front left wheel hub in a neutral (substantially straight steering) configuration.

FIG. 6 is a perspective view of the front left wheel hub in a left turning configuration.

FIG. 7 is a perspective view of the front left wheel hub in a right turning configuration.

FIG. 8 is a left perspective view of a second exemplary embodiment of a wheeled mini-loader (with the side frame walls and some other components removed).

FIG. 9 is a left perspective view of the drive chain case and selected attached components of the loader of FIG. 8.

FIG. 10 is a top plan view of the components of FIG. 9.

FIG. 11 is a left side elevation view of the components of FIG. 9.

FIG. 12 is a top and rear perspective view of the components of FIG. 9.

FIG. 13 is a side perspective view of an exemplary drop steering hub with phantom lines showing interior components.

FIG. 14 is a vertical cross section through the hub of FIG. 13.

FIG. 15 is a left perspective view of a third exemplary embodiment of a wheeled mini loader (with some components shown as transparent).

FIG. 16 is a perspective view of an enlarged portion of the mini loader of FIG. 15, with the left wheels removed.

FIG. 17 is a left perspective view of some drive components of the third exemplary power machine.

FIG. 18 is a top plan view of the components of FIG. 17.

FIG. 19 is a left front perspective view of an exemplary steering assembly of the third power machine.

FIG. 20 is a front perspective view of the steering assembly of FIG. 19.

FIG. 21 is a front and top perspective view of the steering assembly of FIG. 19.

FIG. 22 is a perspective view of an exemplary bell crank casting.

FIG. 23 is a view of the bell crank casting of FIG. 22, rotated to the left about its longitudinal axis.

FIG. 24 is a rear perspective view of a portion of the steering assembly of FIG. 19.

FIG. 25 is a front perspective view of the back left steering assembly in a neutral or straight steering position.

FIG. 26 is a front perspective view of the back left steering assembly, wherein the actuator is extended for a right turn configuration.

FIG. 27 is a front perspective view of the back left steering assembly with the actuator retracted for a left turn configuration.

FIG. 28 is a left perspective view of a fourth exemplary embodiment of a wheeled loader.

FIG. 29 is a side elevation view schematically showing some components of the fourth exemplary loader.

FIG. 30 is a top cross-sectional view taken at line 30-30 of FIG. 29.

FIG. 31 is a partial cross-sectional view showing a front left wheel turned inward on the fourth exemplary loader.

FIG. 32 is a front perspective view showing the frame of a fifth exemplary embodiment of a wheeled loader.

FIG. 33 is a partial top view of the front left wheel of the loader of FIG. 32, with some parts shown as transparent.

FIG. 34 is a perspective view of an exemplary steerable wheel assembly of the fifth exemplary loader.

While the above-identified figures set forth one or-more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for description and should not be regarded as limiting. Words such as “including,” “comprising,” and “having” and variations thereof as used herein are meant to encompass the items listed thereafter, equivalents thereof, as well as additional items.

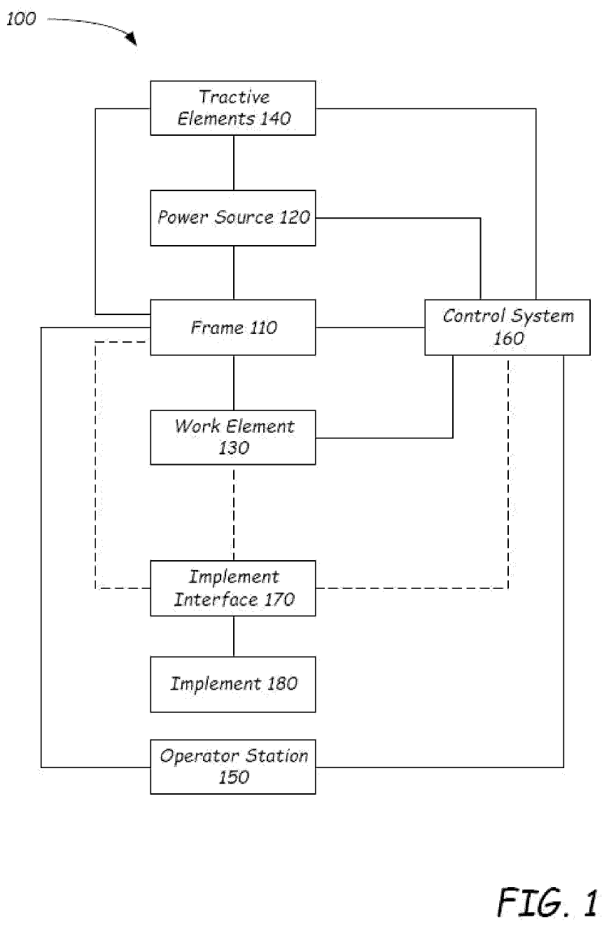

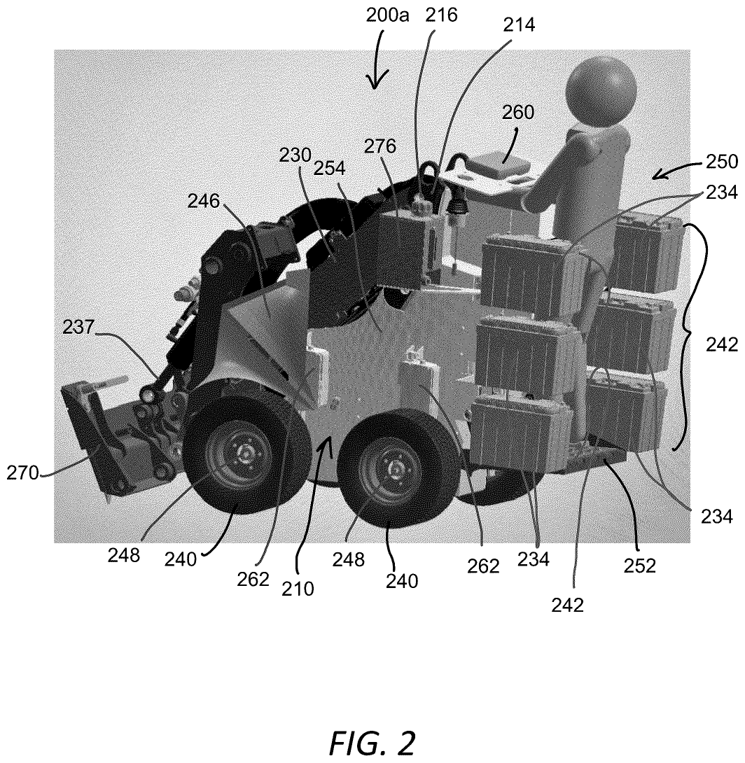

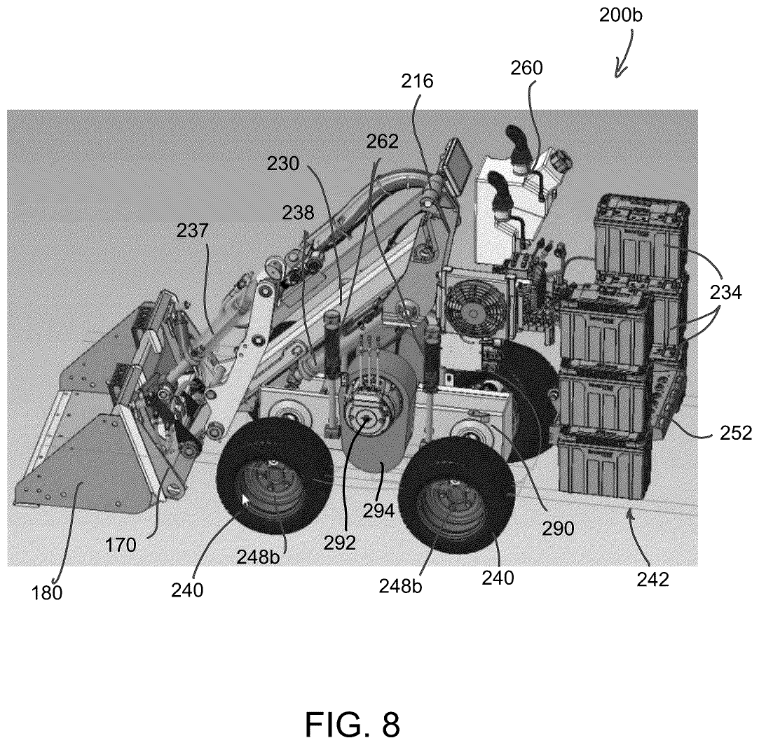

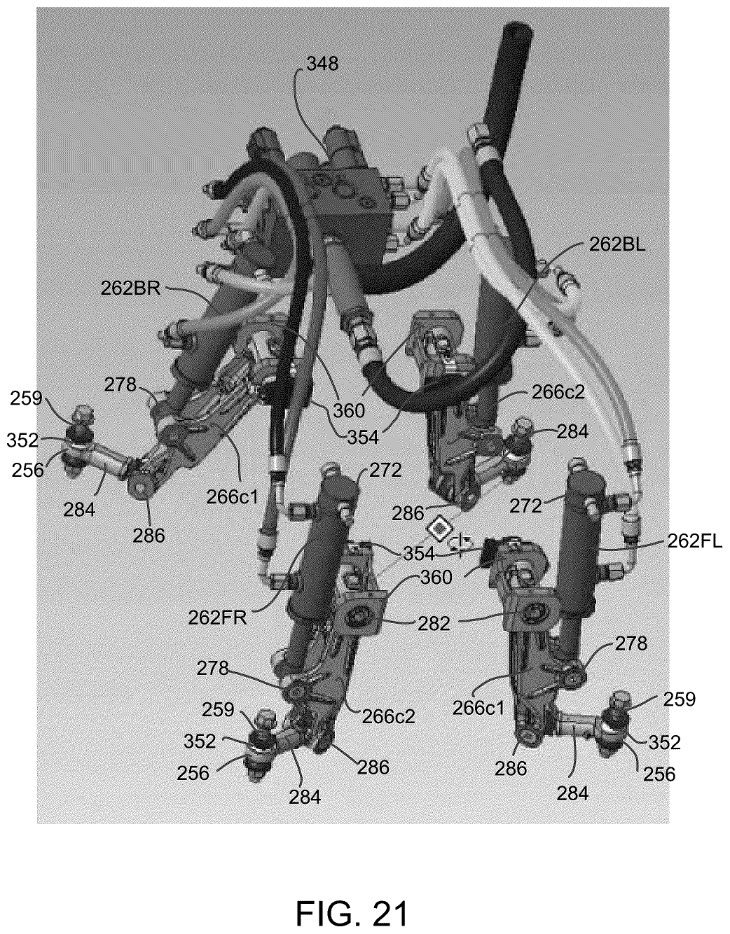

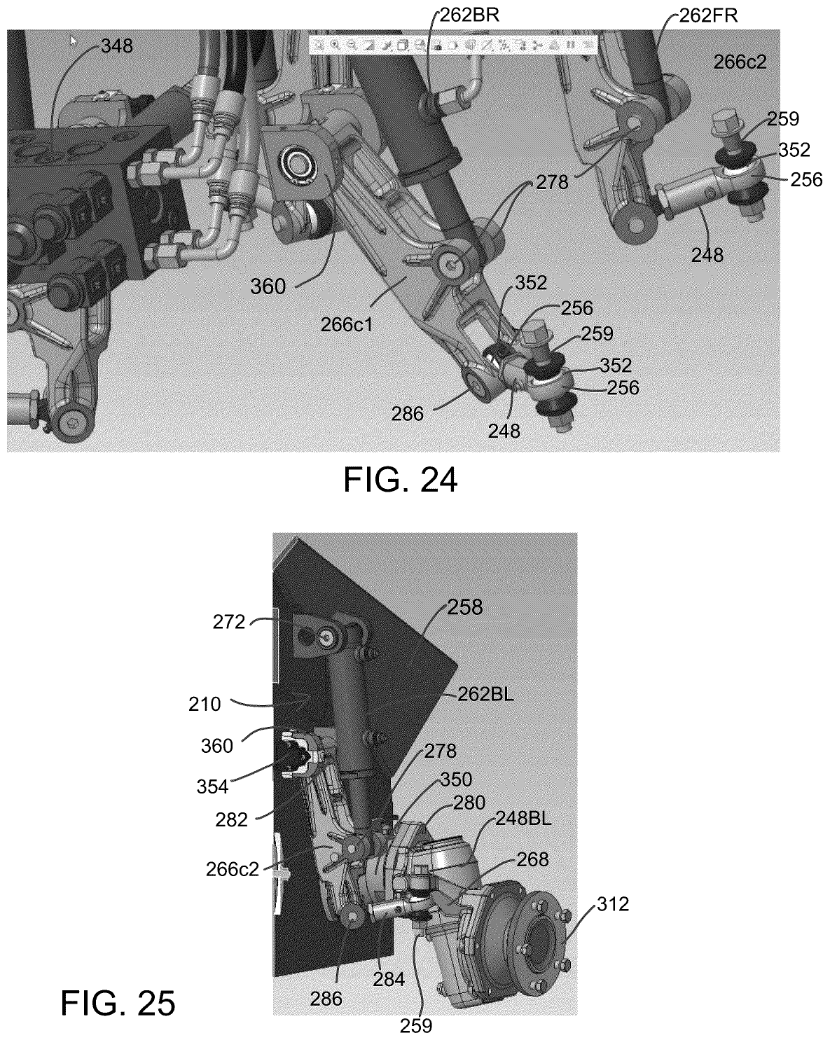

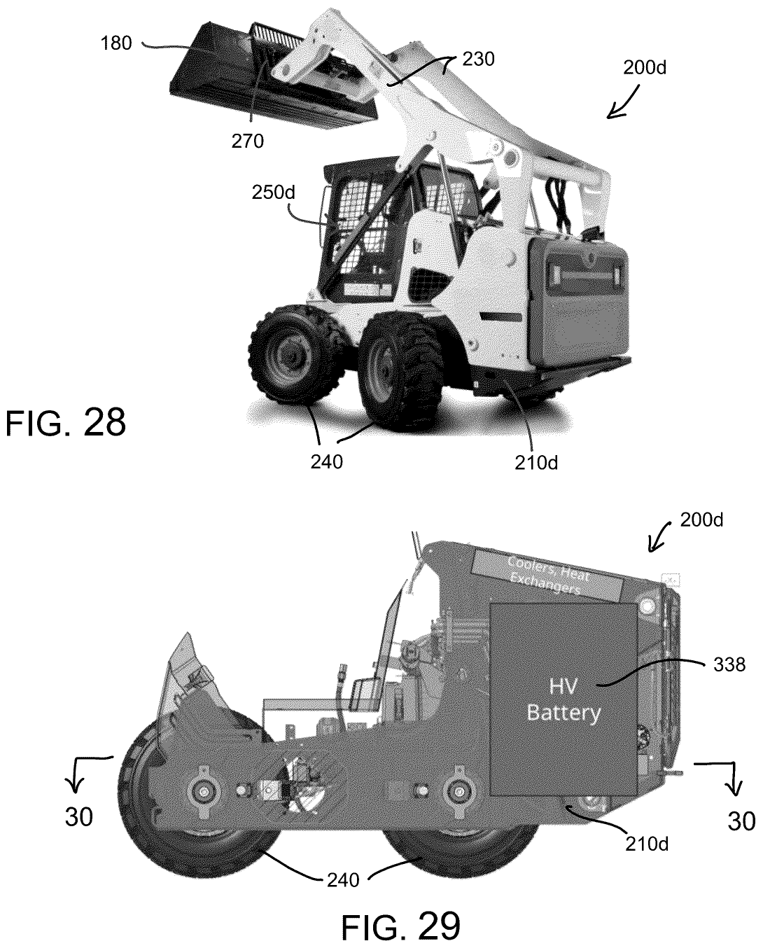

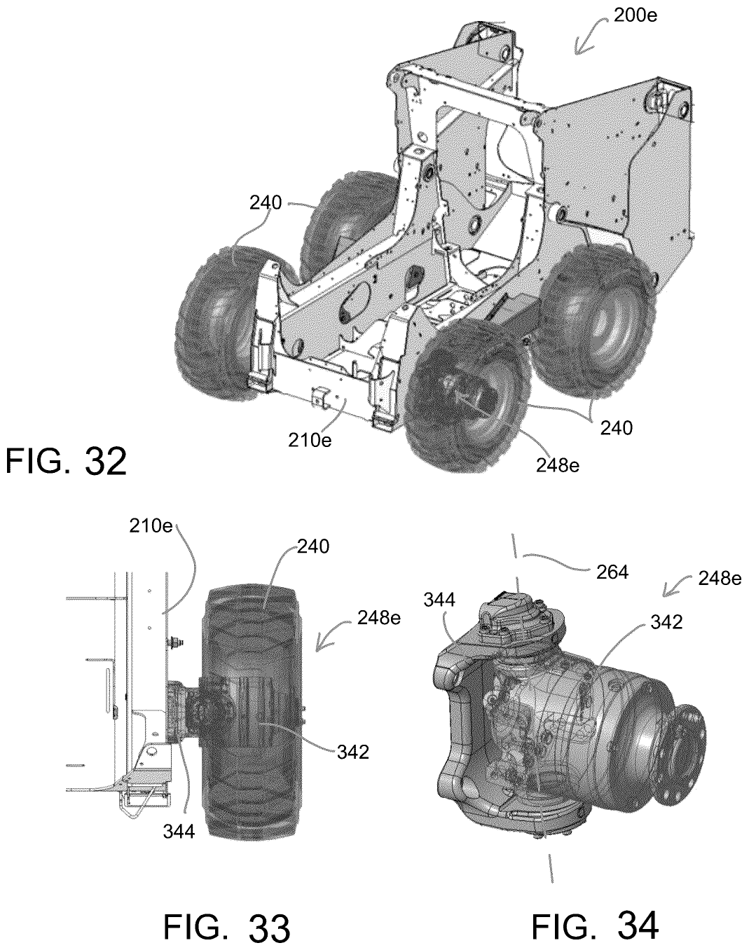

A representative power machine on which the embodiments can be practiced is illustrated in diagram form in FIG. 1, and one example of such a power machine is illustrated in FIGS. 2-7. A second embodiment of a power machine is illustrated in FIGS. 8-14. A third embodiment of a power machine is illustrated in FIGS. 15-27. A fourth embodiment of a power machine is illustrated in FIGS. 28-31. A fifth embodiment of a power machine is illustrated in FIGS. 32-34.

The disclosed teachings can be practiced on any of a number of power machines, including power machines of different types from the representative, illustrated power machines. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

Referring now to FIG. 1, a block diagram illustrates the basic systems of a power machine 100 upon which the embodiments discussed below can be advantageously incorporated and can be any of several distinct types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm structure to which an implement 180 such as a bucket is attached. The work element, i.e., the lift arm structure can be manipulated to position the implement 180 for performing the task. The implement 180, in some instances can be positioned relative to the work element, such as by rotating a bucket relative to a lift arm structure, to further position the implement. Under normal operation of such a work vehicle, the bucket is intended to be attached and under use. Such work vehicles may be able to accept other implements by disassembling the implement/work element combination and reassembling another implement in place of the original bucket. Some work vehicles are intended to be used with a wide variety of implements and have an implement interface such as implement interface 170 shown in FIG. 1. At its most basic, implement interface 170 is a connection mechanism between the frame 110 or a work element 130 and an implement 180, which can be as simple as a connection point for attaching an implement directly to the frame 110 or a work element 130.

On some power machines, implement interface 170 can include an implement carrier, which is a physical structure movably attached to a work element. The implement carrier has engagement features and locking features to accept and secure any of several implements to the work element. One characteristic of such an implement carrier is that once an implement is attached to it, it is fixed to the implement (i.e., not movable with respect to the implement) and when the implement carrier is moved with respect to the work element, the implement moves with the implement carrier. The term “implement carrier” is not merely a pivotal connection point, but rather a dedicated device specifically intended to accept and be secured to various different implements. The implement carrier itself is mountable to a work element 130 such as a lift arm structure or the frame 110. Implement interface 170 can also include one or more power sources for providing power to one or more work elements on an implement. Some power machines can have a plurality of work elements with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates about a swivel with respect to a lower frame portion. Other work vehicles have articulated frames such that one portion of the frame pivots with respect to another portion for accomplishing steering functions.

Frame 110 supports the power source 120, which can provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Additionally or alternatively, power from the power source 120 can be provided to a control system 160, which in turn selectively provides power to the elements that are capable of using it to perform a work function. Power sources for power machines frequently include an engine such as an internal combustion engine and a power conversion system such as a mechanical transmission or a hydraulic system that can convert the output from an engine into a form of power that is usable by a work element. Other types of power sources can be incorporated into power machines, including electrical sources such as batteries or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels, track assemblies, and the like. Tractive elements can be rigidly mounted to the frame such that movement of the tractive element is limited to rotation about an axle or steerably mounted to the frame to accomplish steering by pivoting the tractive element with respect to the frame.

Power machine 100 includes an operator station 150, which provides a position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that can control at least some of the operator-controlled functions on the power machine.

Five specific embodiments of a power machine 200 are described, and in some cases they will be differentiated by referring to the first embodiment with reference number 200a (FIGS. 2-7), the second embodiment with reference to number 200b (FIGS. 8-14), the third embodiment with reference to number 200c (FIGS. 15-27), the fourth embodiment with reference to number 200d (FIGS. 28-31), and the fifth embodiment with reference to number 200e (FIGS. 32-34). However, in many aspects, the power machines are similar; descriptions of power machine 200, 200a, 200b, 200c, 200d or 200e apply to all embodiments unless otherwise specified. This convention also applies to other similarly numbered elements.

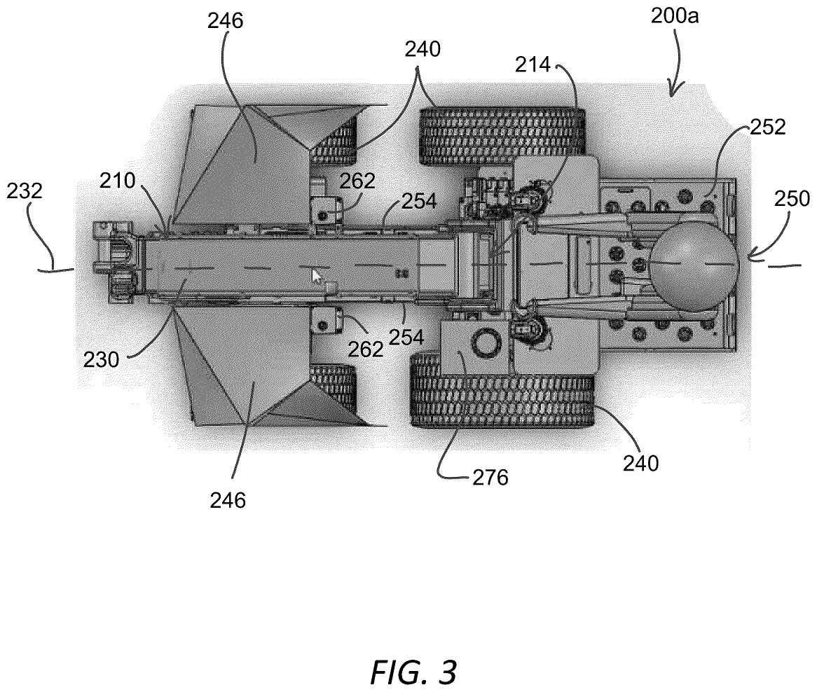

FIGS. 2-7 illustrate a loader 200a, which is one particular example of a power machine of the type illustrated in FIG. 1 in which the embodiments discussed below can be advantageously employed. Some elements are shown in some views and not in others so that parts behind or under those elements can be seen. For example, FIG. 2 shows actuator hoses that are not shown in other views. In FIG. 3, primary batteries 234 have been eliminated.

The loader 200a, 200b is a wheeled loader and more particularly, a mini-loader. A mini-loader for the purposes of this discussion is a small loader relative to other compact loaders such as traditional skid-steer loaders and compact track loaders; typically, a mini-loader does not have an enclosed operator cab. Some mini-loaders have a platform 252 on which an operator can ride, which serves as operator station 250. Other mini-loaders can be operated by an operator who walks behind the loader. Still other mini-loaders have a platform that is moveable or removable to allow an operator to alternatively ride on the platform or walk behind the loader.

The loader 200 should not be considered limiting, especially as to features that the loader 200 may have described herein that are not essential to the disclosed embodiments. Such features may or may not be included in power machines other than the loader 200 upon which the embodiments disclosed below may be advantageously practiced. Unless specifically noted otherwise, embodiments disclosed below can be practiced on a variety of power machines, with the loader 200 being only one of those power machines. For example, some or all of the concepts discussed below can be practiced on many other types of stand-on work vehicles such as mowers, aerators, and spreaders, to name but a few examples. Moreover, while the illustrated embodiment shows a platform configured for a standing operator, the platform can also be used for a seating platform, for example. Still other mini-loaders can be remotely controlled or autonomous, thereby not having an on-board operator station or having an operator station that may not be occupied during operation.

In an exemplary embodiment, loader 200 includes frame 210. The frame 210 supports a power system configured to generate or otherwise provide power for operating various functions on the power machine. In an exemplary embodiment, the power system includes primary batteries 234 and an internal battery (not visible). The frame 210 also supports a work element in the form of a lift arm 230 that is selectively powered by the power system in response to signals from an operator control system 260 and can perform various work tasks. The lift arm 230 in turn supports an implement interface 270, which is configured to receive and secure various implements to the loader 200 for performing various work tasks. The loader 200 can be operated from an operator station 250 from which an operator can manipulate various control devices to cause the power machine to perform various functions. An electrical power source can also include electrical conduits that are in communication with a data bus on the loader 200 to allow communication between operator control system 260 and electronic devices on the loader 200, for example.

In an exemplary embodiment, the frame 210 also supports a traction system (including wheels 240) that is also selectively powered by the power system in response to signals from the operator control system 260. The wheels 240 are configured to propel the power machine over a support surface. Descriptions of directions or orientations are taken with respect to the support surface (e.g., ground surface) as a substantially horizontal surface. Thus, a vertical, up or down direction is substantially perpendicular to a support surface defined by the bottoms of wheels 240. A front or forward direction is at the left of FIGS. 2 and 3 (the implement interface 270 is at the front of power machine 200 as illustrated). A back or rearward direction is at the right of FIGS. 2 and 3 (the operator station 250 is at the rear of power machine 200 as illustrated). “Left” and “right” may be described from the viewpoint of the operator as illustrated.

Various power machines that can include and/or interact with the structures and/or functions of embodiments discussed below can have various frame components that support various work elements. The elements of frame 210 discussed herein are provided for illustrative purposes and are not necessarily the only type of frame that a power machine on which the embodiments discussed below can be practiced can be employed, unless otherwise specifically indicated.

The frame 210 supports the lift arm 230 at pivot bracket 214. The combination of mounting features on the pivot bracket 214 and the lift arm 230 and mounting hardware (including pins and bolts and other fasteners used to attach the lift arm 230 to the pivot bracket 214 and frame 210) are collectively referred to as joint 216. Joint 216 defines a pivot axis (a horizontal axis extending left and right in this example) about which the lift arm 230 is capable of pivoting with respect to the frame 210. In an exemplary embodiment, the lift arm 230 is a single arm centrally mounted along a longitudinal center line 232 of frame 210, as shown in FIG. 3. The lift arm 230 may be formed as one piece or may have telescoping inner and outer tubes to extend a reach of an implement mounted to implement interface 270. Suitable implements such as loader buckets and angle brooms are available commercially from Doosan Bobcat North America, Inc.

In an exemplary embodiment, a lift actuator (positioned under lift arm 230 and not visible) is pivotally coupled to both the frame 210 and the lift arm 230. In an exemplary embodiment, power system is electric, and the lift actuator can be an electric actuator. In another embodiment, the lift actuator can be a hydraulic cylinder powered by a power conversion system and configured to selectively receive pressurized fluid.

Actuation (i.e., extension and retraction) of the lift actuator causes the lift arm 230 to pivot about joint 216 and thereby be raised and lowered along a radial path. The illustrated lift arm 230 is representative of one type of lift arm structure that may be coupled to the power machine 200. Other lift arm structures, with different geometries, components, and arrangements can be pivotally coupled to the loader 200 or other power machines upon which the embodiments discussed herein can be practiced without departing from the scope of the present discussion. For example, a lift arm structure can have two or more portions that are pivotally coupled to each other to create a linkage that permits a more vertical travel path.

An example of an implement interface 270 includes an implement carrier that is configured to accept and secure a variety of different implements to the lift arm 230. Such implements have a machine interface that is configured to be engaged with the implement interface 270. In an exemplary embodiment, the implement interface 270 is pivotally mounted to the lift arm 230, and an implement actuator 237 is operably coupled to rotate the implement interface 270 with respect to the lift arm 230. Other examples of power machines can have a plurality of implement carrier actuators. Still other examples of power machines of the type that can advantageously employ the disclosed embodiments discussed herein may not have an implement carrier as illustrated, but instead may permit implements to be directly attached to its lift arm structure such as by pinning.

An implement power source is available for connection to an implement on the lift arm 230. In a case in which power system is electrical and an implement and/or lift arm 230 is hydraulically powered, a power conversion system can be used, such as one having a hydraulic pump coupled to a rotating shaft of an electric motor, wherein the hydraulic pump is configured to provide pressurized hydraulic fluid to the implement for powering one or more functions or actuators on an implement and/or lift arm 230. For example, a hydraulic gear pump can supply hydraulic oil to the lift cylinder of lift arm 230, implement actuator 237, and any other hydraulic components, such as steering actuators 262 in some cases. In an exemplary embodiment, the hydraulic oil is pumped from reservoir 276, which is located outside of the left frame side wall 254, as shown in FIGS. 2 and 3 for example.

In an exemplary embodiment, a lower portion of frame 210 supports a four attached tractive elements, configured as wheels 240. The wheels 240 rotate under power to propel the loader 200 over a support surface on which the weight of the loader 200 is distributed. In an exemplary embodiment, the operator station 250 is positioned at the rear of the frame 210. Platform 252 is supported on frame 210 by platform bracket. While an operator stands on the platform 252, the operator has access to a plurality of inputs for operator control system 260 that, when manipulated by the operator, can provide signals to control work functions of the power machine 200, including, for example, the traction system including wheels 240 and work group including the lift arm 230 and any attached implement. Operator control inputs can include joysticks, switches, buttons, knobs, levers, variable sliders, roller-ball inputs and other multi-axis input devices, for example. In the illustrated embodiment, the operator station 250 is open to the back of the power machine 200. Similar other power machines, including other mini-loaders, can include operator stations toward the rear of the respective frames, without necessarily being open to the back of the power machines.

In an exemplary embodiment, display devices are provided in the operator station to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be designed to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

In an exemplary embodiment, loader 200 is primarily powered by electricity, and the power system consists of primary batteries 234 (labeled in FIG. 2, for example) and an internal battery (within the frame side walls 254 and therefore not visible). In an exemplary embodiment, each of primary batteries 234 is supported on frame 210 in a quick connect manner (e.g., “hot-swappable”) that allows for convenient replacement of depleted primary batteries 234 with fully charged replacements. In an exemplary embodiment, the primary batteries 234 are placed in two banks 242, with one bank on each of the left and right sides of the operator station 250. In an exemplary embodiment, each bank 242 is supported on frame 210 by battery bracket. In an exemplary embodiment, the banks 242 are located completely rearward of the rear wheels 240 to counterbalance weight loads experienced at the front end of loader 200, especially during operation of an implement 180 such as a loader bucket (see FIG. 8) attached to the implement interface 270.

The weight of the primary batteries 234 effectively balances the weight on the front of the loader, including the weight of the lift arm 230 and any substance held in its connected implement 180. Thus, loader 200 can be semi-autonomous (remotely controlled) or completely autonomous, without the need for the operator's weight to maintain weight balance of the power machine 200. In an exemplary embodiment, even without an operator, loader 200 is preferably configured with about 60% of its weight toward the rear, so that an implement 180 on the front can accommodate additional weight without an unbalance.

Placing the heavy internal battery as low as possible on the undercarriage of frame 210 increases stability of loader 200a. In an exemplary embodiment, an internal battery pack is centered laterally on the undercarriage of frame 210 between the pairs of front and rear hubs 248 and within the frame side walls 254. In an exemplary embodiment, the internal battery is a 48-volt battery, so that the loader 200a is a 48-volt electric power machine. In an exemplary embodiment, the internal battery serves as a reserve, auxiliary or backup battery in case power has been drained from the primary batteries 234. In normal operation, it is preferable to rely first on the electricity provided by the primary batteries 234 because they are more conveniently located for removal, recharging, and replacement.

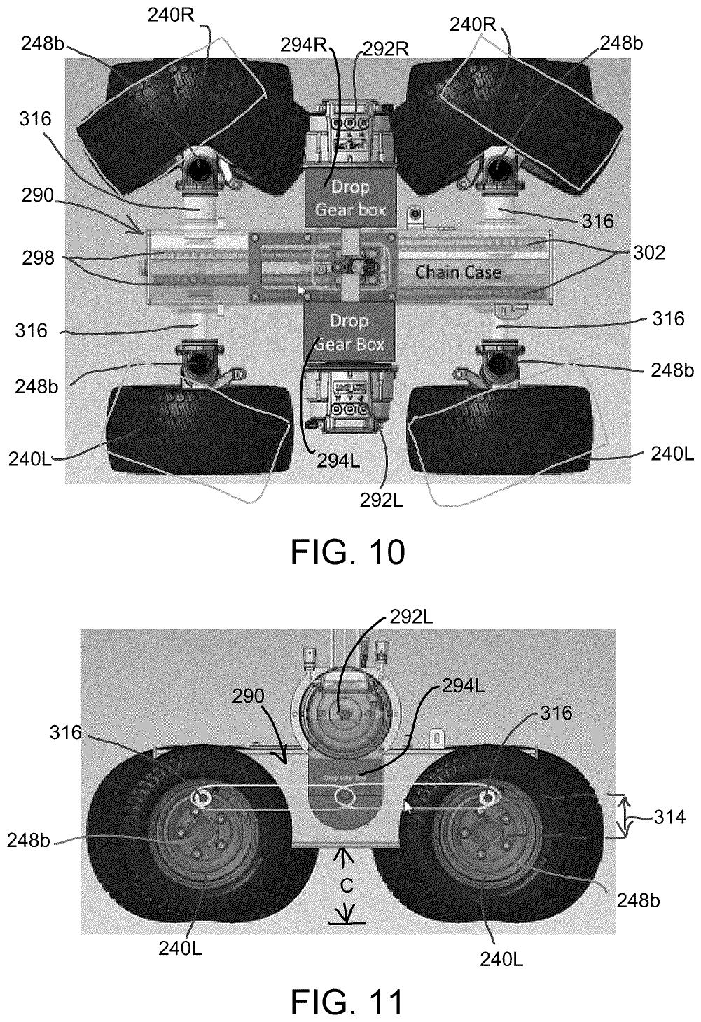

Electric traction motors, which are also heavy and placed low on the undercarriage of frame 210, also contribute to a low center of gravity of loader 200a. In an exemplary embodiment, an electric traction motor is provided for each of the wheels 240. While components for only some of the wheels 240 are visible in the drawings, it is to be understood that all four of the wheels 240 are similarly outfitted, and they are independently steerable for enhanced maneuverability of the loader 200 in many forms of motion, including of course forward and backward motion with left and right turns. Moreover, exemplary embodiments have the ability to run some wheels with a forward rotation simultaneously with other wheels in a rearward rotation, to allow the machine 200 to turn in tight circles about itself (“diamond” steer or “spot” steer, wherein the front wheels turn toward each other at the front of the loader 200, and wherein the rear wheels turn toward each other at the rear of the loader 200, as shown in the phantom lines of FIG. 10) as well as perform in other modes such as crab steer, tank steer, rear wheel steer, front wheel steer, all wheel steer, and coordinated steer, for example.

In an exemplary embodiment, one electric traction motor is provided for each wheel 240. Operation of each of the wheels 240 is independent from that of each of the other wheels. The loader 200 has all wheel steer, and independence of the electric traction motors can provide for traction control assistance. For example, when the loader 200 makes a left-handed turn, the left wheels 240 will spin at a slower speed than the right wheels 240, based on the turning radius and the positions of the wheels relative to each other while making a turn. To increase traction, the respective traction motors can be slowed down or sped up to control wheel slippage.

In an exemplary embodiment, the electric traction motors are positioned on the undercarriage of frame 210 and within the frame side walls 254. In an exemplary embodiment, each electric traction motor is a three-kilowatt motor. The two motors for the front left and front right wheels 240 are placed closely adjacent to each other in front of the internal battery. The two electric motors for the left and right rear wheels 240 are placed closely adjacent each other and behind the internal battery.

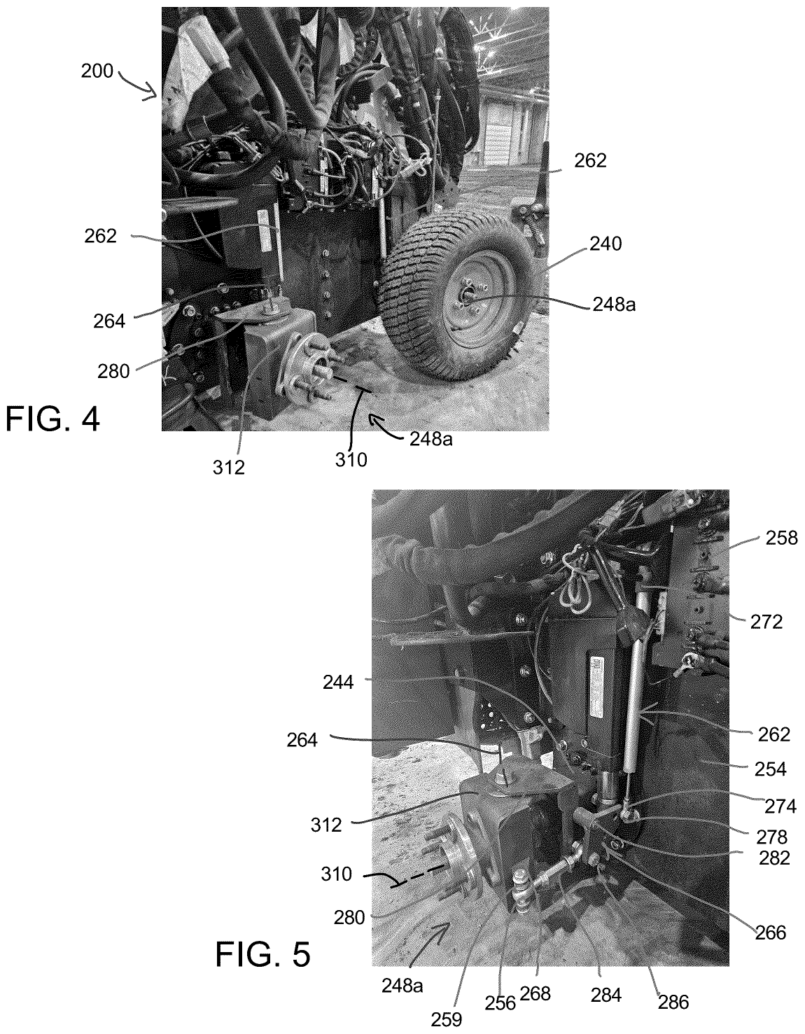

FIG. 3 is a top plan view of loader 200a, illustrating its very compact frame 210. Of note, the undercarriage is very narrow so that the wheels 240 can turn quite sharply about the planetary gears 244 (shown in FIG. 5), wherein a planetary gear 244 for a respective wheel 240 essentially serves as its axle and is mounted outside of the undercarriage of frame 210 (see FIGS. 4-7). This allows the loader 200 to have a very tight turning radius, thereby enhancing its maneuverability. As shown in FIGS. 2 and 3, front covers 246 are located above the front wheels 240 and do not thereby interfere with their turning during steering.

As shown in FIGS. 2 and 8, joint 216 for lift arm 230 in an exemplary embodiment is positioned high on main frame 210, rearward of the hubs 248 for front wheels 240 and forward of the hubs 248 for rear wheels 240. Placing the joint 216 high on the frame 210 allows the lift arm 230 to have a relatively long length dimension for a small machine 200. Moreover, positioning joint 216 in front of the operator station 250 enables the use of a single centrally mounted lift arm 230 that is placed on the longitudinal centerline 232 of loader 200 (see FIG. 3). This results in a small, simplified and well-balanced machine with robust work capabilities. In an exemplary embodiment, the entire power machine 200 is about 36 inches wide (measured along a dimension perpendicular to center line 232), allowing it to travel through gates, doorways, and other narrow spaces with ease.

Because the frame 210 is so narrow, a planetary gear 244 for loader 200a is operably connected to each electric traction motor and is positioned outside of the frame 210. Thus, each planetary gear 244 essentially serves as the axle for its respective hub 248 for a respective wheel 240. For each wheel set, the electric motor in an exemplary embodiment spins at about 3,000 rotations per minute (rpm). In an exemplary embodiment, planetary gear 244 includes a 15-to-1 reduction gear box to reduce the motor speed to a much lower nominal speed of about 200 rpm, which is much more suitable for driving the wheels 240 on hubs 248.

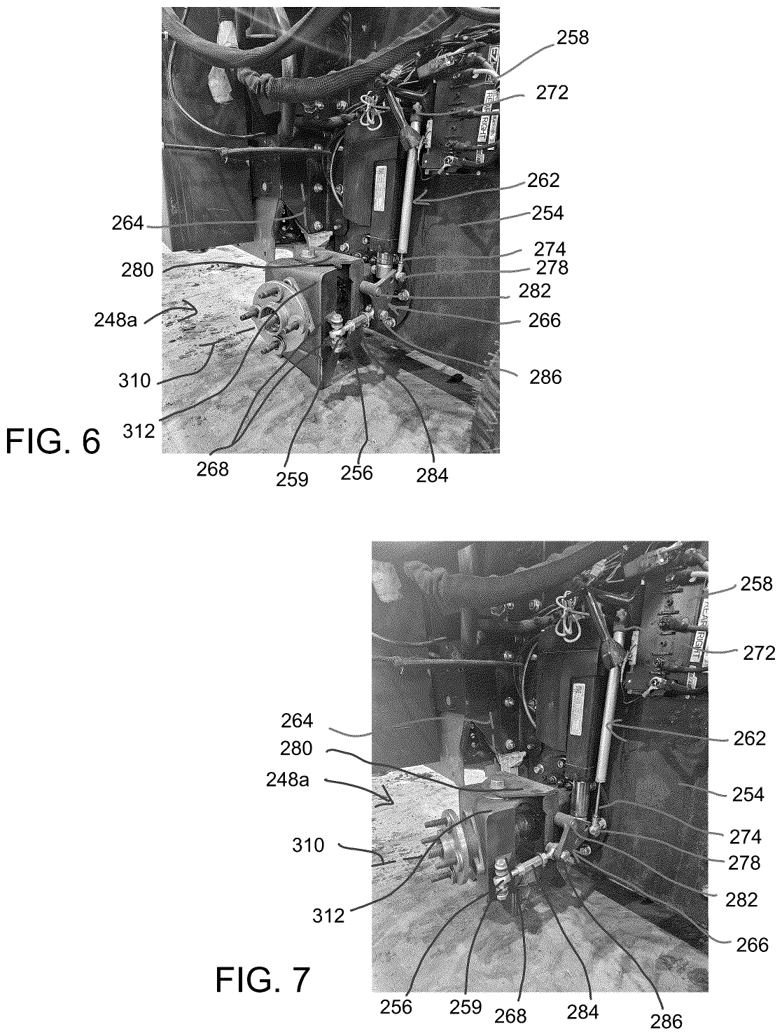

FIG. 4 is a left side perspective view of a portion of loader 200a with the left front wheel removed from its hub 248. FIG. 5 is a rear perspective view of the left front hub 248 in a neutral position, with the steering actuator configured so that a wheel attached to the hub 248 would travel in a substantially straight motion. FIG. 6 shows the hub 248 turned to cause a left turning forward motion. FIG. 7 shows the hub 248 turned to cause a right turning forward motion. Descriptions of the positions of the hub 248 in the discussion with reference to FIGS. 4-7 is simplified to show the mechanics of the turning of a single hub. However, it is to be understood that turning or motion of the entire machine is reliant not only on a single hub position but on the configurations of each of the four hubs 248 for each of the respective four wheels 240, and the direction of wheel rotation.

As shown in FIG. 5, hub 248 is in a neutral position for substantially straight forward or backward motion of a wheel attached thereto. Each steering actuator 262 is vertically oriented on frame 210 and positioned outside the frame side wall 254. A top or base end 272 of the steering actuator 262 in an exemplary embodiment is positioned at a fixed location on frame 210. A second opposite bottom or rod end 274 of steering actuator 262 is pivotally connected to bell crank 266 at pivot joint 278. Stationary hub frame 280 is attached to planetary gear 244 and carries a steering pivot that defines vertical axis 264 about which the hub plate 312 pivots for steering motions. In an exemplary embodiment, bell crank 266 has a pivotal connection at joint 282 to the hub frame 280. In an exemplary embodiment, rigid link 284 is attached to a third pivot joint 286 of bell crank 266. In an exemplary embodiment, an opposite end of link 284 is pivotally connected to hub plate 312 at steering connection tab 268. In an exemplary embodiment, an end of link 284 has an eyelet 256 through which shaft 259 extends. Ends of shaft 259 are attached to the steering connection tab 268 of hub plate 312, and shaft 259 can rotate within the eyelet 256. In an exemplary embodiment, bell crank 266 has a generally triangular configuration defined by the three pivot joints 278, 282, 286. Thus, the vertical motion at steering actuator 262 is translated into horizontal motion at link 284 with very little space needed in the width dimension of the loader 200.

As shown in the neutral steering position of FIG. 5, steering actuator 262 is in an intermediate extension configuration, and the pivot joints 278, 282 are generally at the same horizontal level. As shown in FIG. 6, to steer the hub 248 for a forward left turn, the steering actuator 262 is retracted to pull upward on pivot joint 278. The bell crank 266 rotates about pivot joint 282 to pull link 284 toward frame side wall 254, thereby pulling on the attached rigid link 284 and hub plate 312. As shown in FIG. 7, in a right turning steering operation, actuator 262 extends in length, thereby pushing downward at pivot joint 278. The bell crank 266 rotates about pivot joint 282 to push link 284 away from frame side wall 254, thereby pushing on the attached hub plate 312.

Each of the four wheels 240 is set up similarly, each having its own controller 258 for independent steering of each of the four wheels 240. The four controllers 258 for the four respective wheels 240 can be linked to operator controls 260 for manual turning of each wheel 240. Additionally or alternatively, the controllers 258 can be operably linked to software that allows an operator to select among various modes of motion (for example diamond steer, crab steer, etc.) and the controllers 258 can send signals to the respective actuators 262 to control their respective extension positions to provide the wheel placements suitable for the selected mode of machine motion. Each wheel 240 is steerable independently of each of the other wheels 240.

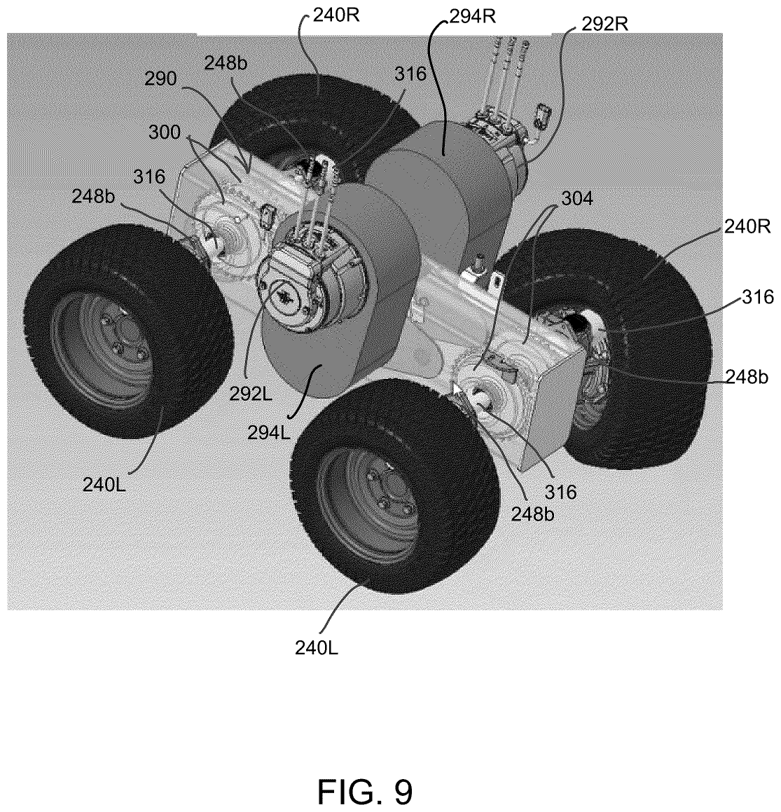

FIG. 8 is a side perspective view of a second exemplary embodiment of loader 200b with a different drive system, configured herein as a drive chain case 290. In FIG. 8, the frame 210 is not shown so that components within the frame side walls can be seen. FIGS. 9-12 show various perspective views of the drive mechanisms, wherein the drive chain case 290 in some views is shown as transparent so that sprockets and chains within the case are visible. In FIGS. 8-12, the left wheels 240L are depicted as in a neutral or straight position, while the right wheels 240R are shown in their full range of motion. The steering mechanism for each of these wheels 240 is substantially similar to the steering system explained with reference to drawing FIGS. 4-7, including steering actuators 262, bell crank 266, and link 284 connected to hubs 248. Therefore, those details regarding the steering will not be repeated with respect to this loader 200b embodiment.

In an exemplary embodiment, each vertically oriented and extending steering actuator 262 is mounted outside of the frame side wall 254 proximate each wheel 240. Vertical extension and retraction of each steering actuator 262 is translated into pivotal motion of hub 248b about its steering axis 264 by bell crank 266 and link 284. In an exemplary embodiment, a controller 258 for each of the steering actuators 262 is positioned on the outside of the frame side wall 254 adjacent its respective actuator 262. In exemplary embodiments, the steering actuators 262 could be electric actuators or they could be hydraulic actuators.

As shown in FIGS. 9-12, in an exemplary embodiment, two electric traction motors 292 are provided, each of them providing a motive force for two of the wheels 240. In an exemplary embodiment, a left electric traction motor 292L drives the two left wheels 240L, and a right electric traction motor 292R drives the two right wheels 240R. Each electric traction motor 292 in an exemplary embodiment is mounted high on a drop gear box 294. In an exemplary embodiment, suitable motors and drop gear boxes are available from Omni Powertrain Technologies of Houston, Texas.

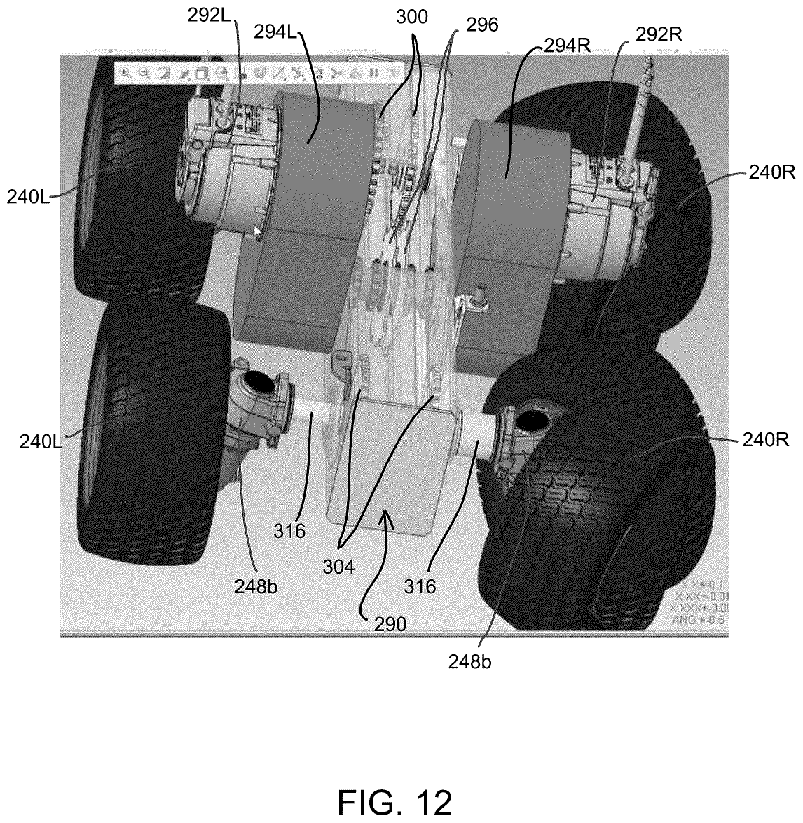

In an exemplary embodiment, rotational power from each of the electric traction motors 292 is reduced by about 11.8 by the planetary gears in each of the respective drop gear boxes 294. As shown in FIG. 12, left and right drive sprockets (within emergency parking brake 296) are connected to the planetary gears within the respective drop gear boxes 294L, 294R to move forward chains 298 (labeled in FIG. 10) about forward driven sprockets 300 (labeled in FIG. 9) and to move rearward chains 302 about rearward driven sprockets 304. While the illustrations and descriptions refer to a chain case with a chain power drive, it is to be understood that the power drive can instead or additionally include belts or gear trains. Other drive components such as cap screws, washers and bearings, for example, are described in commonly-owned U.S. Pat. No. 8,016,065 for “Split chaincase with fixed axles,”which is hereby incorporated by reference.

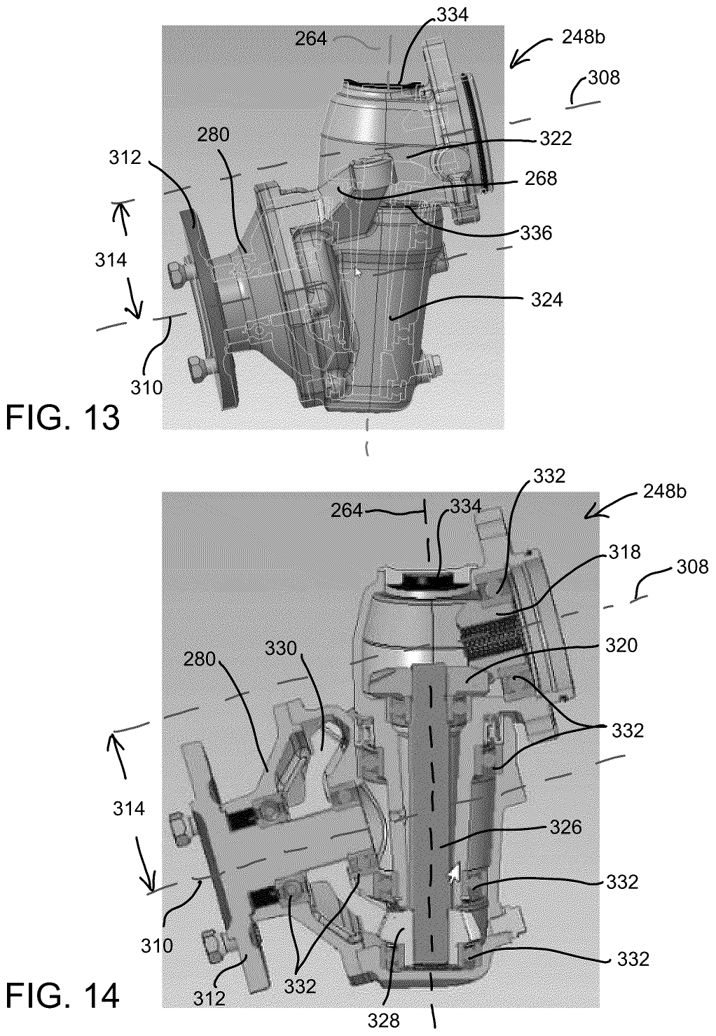

In an exemplary embodiment, each of the hubs 248b is a drop steering knuckle hub, also known as a steerable tractor hub, as shown in FIGS. 13 and 14. Such an exemplary hub 248b has a vertical offset, displacement, or “drop” between the input shaft axis 308 (also the rotation axis of axle 316) and the wheel axis 310 at the hub plate 312. This vertical offset distance 314 can also be referred to as the vertical hub drop and results in loader 200b having an excellent ground clearance between the ground surface and a bottom of the drive chain case 290, which also represents a bottom of the loader frame 210. The ground clearance C is illustrated in FIG. 11 and in some embodiments is about 7 or 8 inches.

In an exemplary embodiment, the upper portion 322 (labeled in FIG. 13) of steerable hub 248b is fixed relative to the drive chain case 290. However, the lower portion 324 pivots about the steering pivot axis 264, which runs through drop shaft 326, as a wheel 240 attached to the hub plate 312 is steered by actuator 262 and bell crank 266. Joint 336 marks the demarcation between the stationary upper portion 322 and the rotatable lower portion 324, to which the wheel 240 is bolted at hub plate 312.

Referring to FIGS. 12-14, in an exemplary embodiment, an axle 316 extends from each of the driven sprockets 300, 304 into the input gear 318 of a respective hub 248b. Input gear 318 interacts with bevel gear 320 for a gear reduction. In an exemplary embodiment, another gear reduction is provided between lower gear 328 and hub gear 330. In an exemplary embodiment, the combined gear reductions of hub 248b amount to a reduction ratio of about 4.5. Bearings 332 facilitate the rotational motions of these various components. In an exemplary embodiment, a sensor can be mounted on sensor mount surface at cap 334 to relay information about the steering position of hub plate 312 relative to the stationary upper portion 322, for example. Other sensors can include speed sensors, as described in U.S. Pat. No. 6,807,809 for “Motion stop control for a vehicle,” and U.S. Pat. No. 6,486,653 for “Mounting arrangement for a wheel speed sensor,” which are hereby incorporated by reference.

In an exemplary embodiment, the drive system of loader 200b has a double reduction in the drive ratios. The first reduction is at the drop gear box 294 and in an exemplary embodiment is a reduction ratio of about 11.84. In an exemplary embodiment, there is no reduction within the drive chain case 290 itself, as the sprockets have a 1 to 1 ratio. The second reduction is in the hub 248b, with a ratio of about 4.52. Accordingly, the overall gear reduction in the drive assembly of loader 200b between an electric traction motor 292 and wheel 240 is about 53.5 to 1. An exemplary loader 200 can be operated at a top speed of about 6 miles per hour.

In an exemplary embodiment, each drop gear box 294 is centered between the two wheels 240 on one side of the drive chain case 290. Moreover, the traction motors 292 are positioned high on a respective drop gear box 294, and each motor 292 is positioned above the wheels 240 so as to not interfere with their turning mobility. In an exemplary embodiment, each hub plate 312 is configured to turn in opposed left and right directions with a range of motion of about 45 radial degrees about axis 264 in each of the left and right directions.

As shown in FIGS. 8 and 12 for example, the configuration of loader 200b as described, with centrally positioned electric traction motors 292 high on drop gear boxes 294, allows for a full range of turning motion of the wheels 240 on dropped hubs 248b. This structure positions the drive components out of the way of the wheels 240, allowing for a power machine 200b that has a short wheel base, a narrow width, high ground clearance and tight maneuverability.

In an exemplary diamond steer pattern, referring to FIG. 10 and the wheel turn configurations of the phantom lines, the front left wheel and the rear right wheel are turned to the right while the front right wheel and the rear left wheel are turned to the left. In one exemplary turning method, the two right wheels 240R would spin forward while the two left wheels 240L are driven backwards, so that the power machine spins about itself like a top, with a full turn in about three feet of space.

FIGS. 15-27 show a third exemplary embodiment of a power machine 200c that is similar to the second machine 200b but has a different configuration for the bell crank. In many aspects, these machines are similar, and elements that are common in structure and function are not described again. In machine 200c, there is more variation in the structures applicable to each of the wheels 240. Therefore, in the illustrations, the wheels and associated structures are designated as FL (front left), BL (back left), FR (front right), and BR (back right).

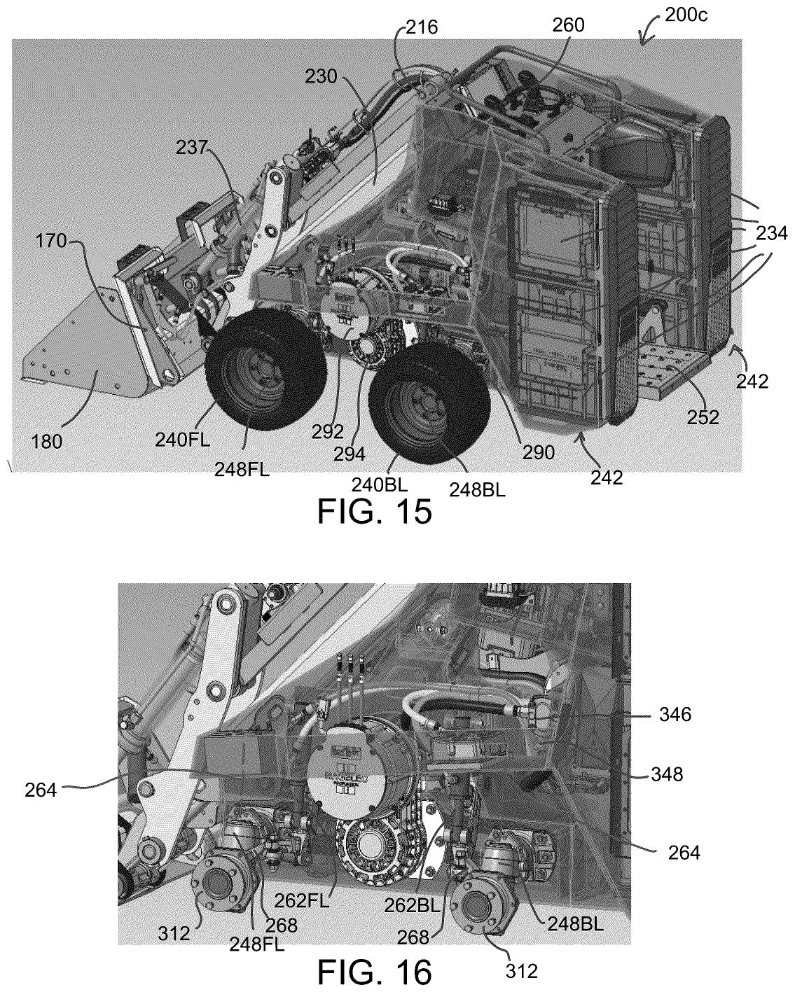

FIG. 16 is an enlarged view of a portion of FIG. 15, with the wheels 240 removed so that the wheel hub 248 and associated steering mechanisms are visible. Motor 246 for pumps for the steering work group connects to manifold 348 for the four steering cylinders 262. The steering actuator 262 for each of the wheels is positioned between the respective wheel hub 248 and the assembly of electric traction motor 292 and drop gear box 294. Thus, for the front wheels, the steering mechanisms are positioned behind the wheels. For the back wheels, the steering mechanisms are positioned in front of the wheels.

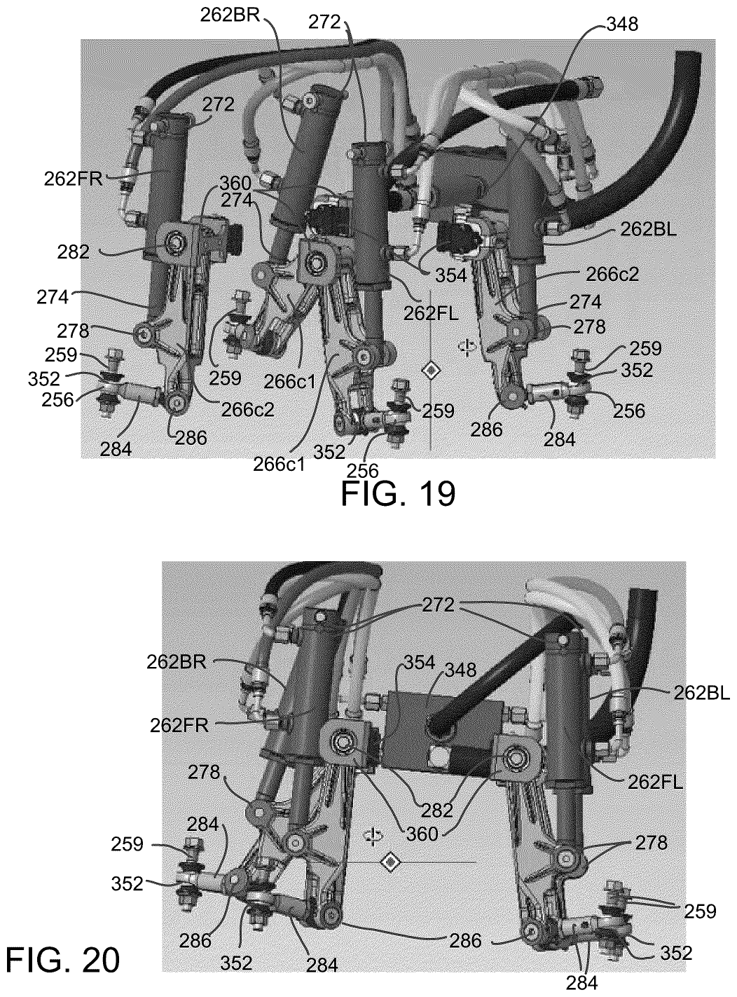

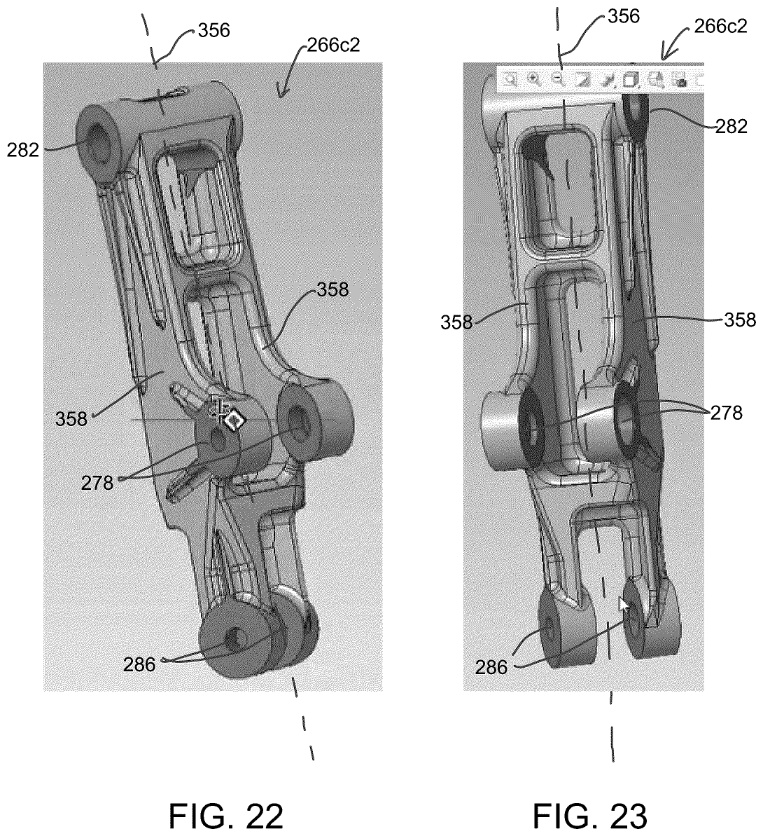

Referring to FIGS. 19-21, because of this asymmetry, the bell crank 266c1 for the front left hub 248FL has a mirror image configuration (about its longitudinal axis 356, see FIGS. 22 and 23) compared to the bell crank 266c2 of the back left wheel hub 248BL. Moreover, the bell crank 266c1 has the same configuration for the front left and back right wheels. Similarly, the bell crank configuration 266c2 is the same on the back left wheel as on the front right wheel.

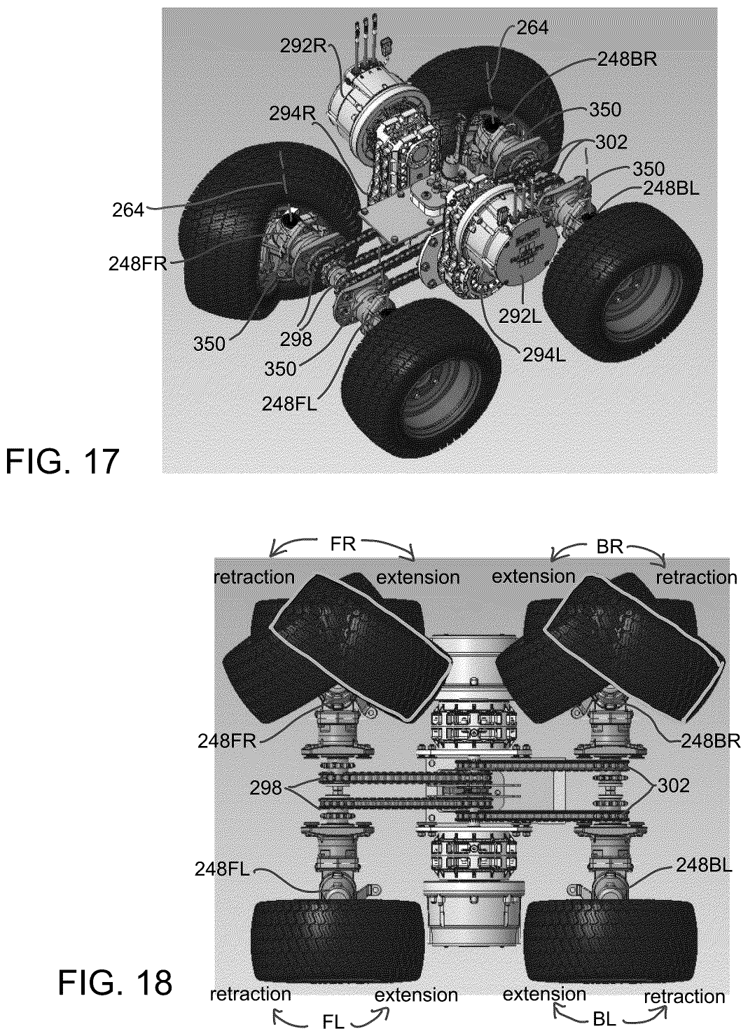

FIG. 17 is a front and left perspective view of some of the drive components of power machine 200c. The left front and left back wheels are shown in a straight or neutral configuration, while a full range of motion is illustrated for the front and back right wheels. FIG. 18 is a top view of the components of FIG. 17, where the highlighted wheel configurations on the right side of the machine correlate to the steering cylinder extensions shown in FIGS. 19-21.

Referring to FIGS. 19-21, the front left and back right steering assemblies have the same configuration of bell crank 266c1. The front right and back left wheel assemblies have the same configuration of bell crank 266c2, which is a mirror image about a longitudinal axis 356 of the structure of bell crank 266c1 (see FIGS. 22 and 23). Returning to FIG. 18, because of this asymmetry, and as illustrated in the highlighted wheel positions on the right side of the power machine, the front right wheel is turned to the right by extension of its steering actuator 262FR, while the back right wheel is turned to the right by retraction of its steering cylinder 262BR. These steering actuator positions are shown in FIGS. 19-21, wherein cylinder 262FR is fully extended, cylinder 262BR is fully retracted, and each of the left cylinders 262FL and 262BL is in an intermediate extension configuration.

Hubs 248FL, 248BL are in a neutral position for substantially straight forward or backward motion of a wheel attached thereto. Referring to FIG. 25, each steering actuator 262 is substantially vertically oriented on frame 210 and positioned outside the frame side wall 254. A top or base end 272 of the steering actuator 262 in an exemplary embodiment is attached to pivot bracket, which is positioned at a fixed location on frame 210. A second opposite bottom or rod end 274 of steering actuator 262 is pivotally connected to bell crank 266c at pivot joint 278. Stationary hub frame 280 is attached to bearing carrier 350; hub 248 carries a steering pivot that defines vertical axis 264 about which the hub plate 312 pivots for steering motions (see FIG. 17). In an exemplary embodiment, rigid link 284 is attached to a third pivot joint 286 of bell crank 266c. In an exemplary embodiment, an opposite end of link 284 is pivotally connected to hub 248 at steering connection tab 268 via shaft 259. In an exemplary embodiment, an end of link 284 has an eyelet 256 through which shaft 259 extends. In an exemplary embodiment, eyelets 256 at each end of link 284 can rotate about spherical bearings 352. The freedom of motion about spherical bearings 352, along with the twisted configuration of bell crank 266c explained below, allow for effective turning control of each wheel 240 in a small amount of horizontal space, with little vertical displacement. It is to be understood that spherical bearings 352 can be enclosed in a factory sealed ball joint in a power machine 200 for protection and durability.

Referring to FIGS. 19-21, steering sensors 354 monitor the rotation of each of the bell cranks 266c to relay information to an operator or automatic controller on the position of each steering assembly. This facilitates use of different steering modes on power machine 200c, such as diamond steer, all wheel steer, crab steer, etc.

FIGS. 22 and 23 show perspective views of an exemplary bell crank 266c2, as used on the front right and back left steering assemblies of the illustrated power machine 200c. In an exemplary embodiment, bell crank 266c2 exhibits a twist along the longitudinal axis 356 between its two arms 358 at pivot point 286 compared to the arms 357 at pivot point 278. The bell crank 266c1 for the front left and back rear wheel assemblies would have an opposite twist than that illustrated in FIGS. 22 and 23. A twist angle of about 33.5 radial degrees is illustrated, though other configurations can also be suitable.

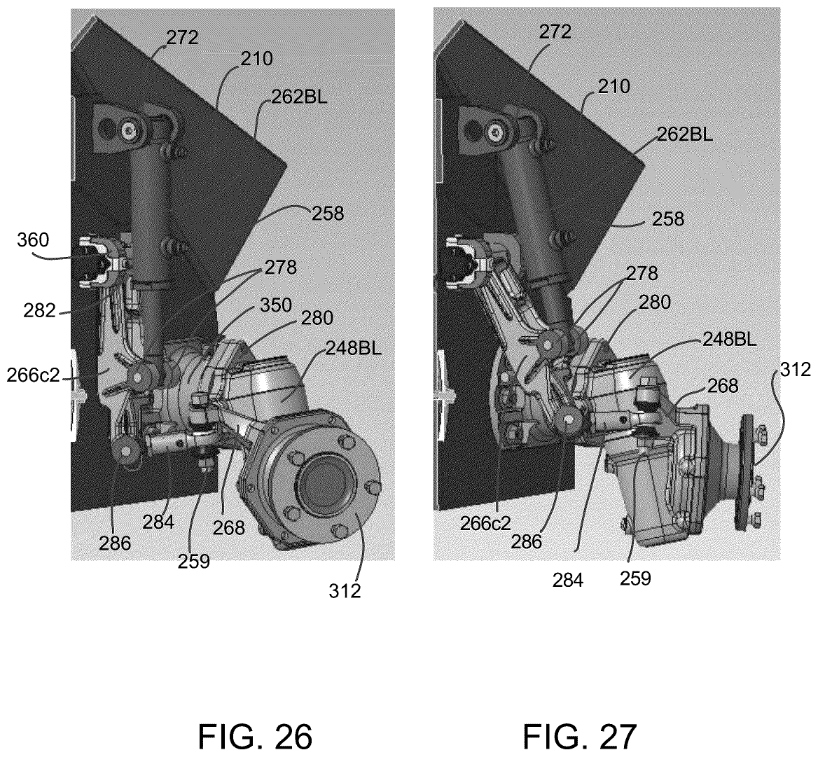

FIGS. 25-27 show the back left wheel hub 248BL attached to the bell crank 266c2 in a steering assembly, showing relations between extension of the steering cylinder 262BL and the orientation of the hub plate 312 to which the wheel 240 is attached. As shown in FIG. 25, the steering cylinder 262BL is in an intermediate extension configuration, and the hub plate 312 is in a neutral or straight steering position. As shown in FIG. 26, the steering actuator 262BL is extended for a right turn, and FIG. 27 shows the steering actuator 262BL retracted for a left turn. In an exemplary embodiment, bell crank 266c is about 8 to about 15 inches long, and link 284 is about 2.5 inches long.

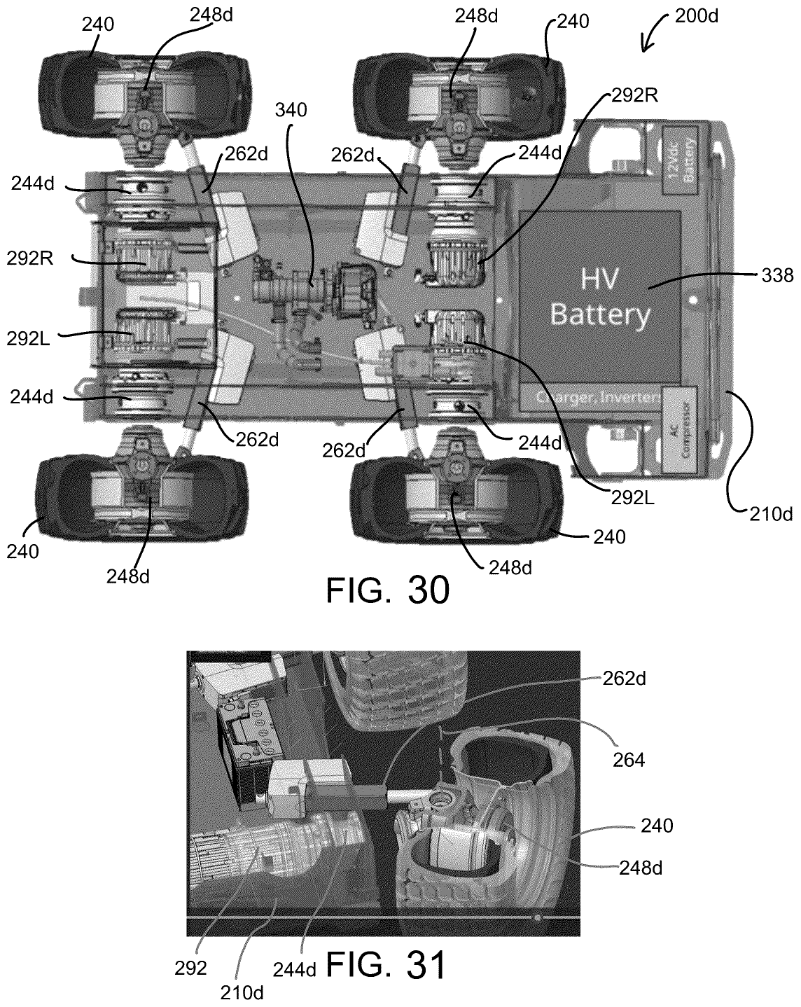

FIGS. 28-31 show views of an exemplary fourth embodiment of an all wheel steer loader, wherein the frame 210d of loader 200d is larger than the frame 210 illustrated for the mini-loaders 200a, 200b, 200c. The illustrated loader 200d has a frame 210d that is commonly referred to as a midsize or extended midsize loader frame. As shown in FIGS. 29 and 30, in an exemplary embodiment, loader 200d has an electric drive train powered by high voltage (HV) battery 338.

As shown in FIGS. 30 and 31, in an exemplary embodiment, each wheel 240 is associated with a respective wheel hub 248d that is steerable about axis 264 by extension and retraction of a horizontally oriented steering actuator 262d. In the drawing figures, some casting elements are not shown, though it should be understood that an attachment casting would be positioned between hub 248d and frame 210d. In the illustrated embodiments, each wheel 240 is independently driven by an electric traction motor 292 through its associated planetary gear 244. In other embodiments, the motor could by hydraulic. In an exemplary embodiment, each planetary gear 244d is a two stage or double planetary inline gear box commercially available from Bonfiglioli SPA of Italy. In an exemplary embodiment, the steering direction, rotation direction, and rotation speed of each wheel 240 is completely independent of that of any other wheel 240 on the loader 200d.

As shown in FIG. 30, in an exemplary embodiment, hydraulic pump assembly 340 is centrally positioned relative to frame 210d between the left electric traction motors 292L and the right electric traction motors 292R. Moreover, in an exemplary embodiment, hydraulic pump assembly 340 is centrally positioned rearward of the two front electric traction motors 292 as well as forward of the two rear electric traction motors 292. In an exemplary embodiment, hydraulic pump assembly 340 includes multiple gear pumps having different flow characteristics to feed various functions on the loader 200d. For example, the hydraulic pump assembly 340 supplies hydraulic fluid, such as may be used by hydraulic cylinders for actuation of the lift arm 230, as shown in FIG. 28, as well as an implement actuator for implement 180. Moreover, in some cases the steering actuators 262d are electric but in a case where the steering actuators 262d are hydraulic, the hydraulic pump assembly 340 would also supply fluid to those actuators. Power conversion systems are used to convert the electric power from HV battery 338 to operate hydraulic devices as needed.

FIGS. 32-34 show components of a fifth exemplary embodiment of a loader 200e, wherein each of the wheel hubs 248e includes a steerable hydraulic motor 342. Thus, as shown, the traction motors 342 are positioned outside of the frame 210e. A suitable steerable wheel hub 248e is commercially available from Poclain Hydraulics North America of Yorkville, Wisconsin. Steering features for the hub 248e can include a vertical actuator and bell crank assembly as discussed above with respect to FIGS. 4-7 or a horizontal actuator system, as discussed with respect to FIGS. 30 and 31, for example. The power source for the steerable wheel hub 248e could be hydraulic. Alternatively, a steerable wheel hub 248e may have an electric traction motor 342, for example. In an exemplary embodiment, traction motor 342 pivots relative to casting 344 about the steering pivot axis 264.

Exemplary, non-limiting embodiments of power machines are described. While these descriptions relate to the illustrative embodiments for ease of understanding, it is to be understood that the subject matter is not limited to these examples.

In one aspect, a power machine 200 comprises a frame 210, a plurality of wheels 240, a steering actuator 262, a hub 248, a link 284 and a bell crank 266. The plurality of wheels 240 are in contact with a ground surface that serves as a horizontal reference. The steering actuator 262 is mounted on the frame 210 and is configured for substantially vertical extension and retraction. The hub 248 comprises a stationary portion 280, 322 and a rotatable portion 312, 324, wherein one of the plurality of wheels 240 is mounted on the rotatable portion 312, 324 to pivot about a first axis 264 with respect to the stationary portion 280, 322. The link 284 has a first end pivotally connected to the rotatable portion of the hub 248. The bell crank 266 comprises first, second and third pivot joints. The first pivot joint 278 of the bell crank 266 is attached to an end 274 of the steering actuator 262, the second pivot joint 282 of the bell crank is attached to a pivot bracket 360, which is in turn attached to frame 210, and the third pivot joint 286 of the bell crank is attached to a second end of the link 284.

In an exemplary embodiment, the link 284 is configured to move substantially horizontally as the end 274 of the steering actuator 262 moves substantially vertically. In an exemplary embodiment, the hub 248b comprises a gear reduction, such as at the interface between input gear 318 and bevel gear 320 and/or at the interface between lower gear 328 and hub gear 330. In an exemplary embodiment, the first end of the link 284 is pivotally connected to the rotatable portion 312, 324 of the hub by a connection tab 268.

In an exemplary embodiment, the frame 210 comprises left and right side walls 254, and the steering actuator 262 and link 284 are positioned entirely outside the left and right side walls 254. In an exemplary embodiment, the frame 210 comprises a drive chain case 290. In an exemplary embodiment, an axle 316 corresponding to the one of the plurality of wheels 240 extends from the drive chain case 290 into the hub 248b, and a wheel axis 310 of the one of the plurality of wheels 240 is vertically displaced from the axle 316, such as by vertical hub drop distance 314. In an exemplary embodiment, the steering actuator 262 is one of four steering actuators 262, wherein each of the four steering actuators 262 corresponds to one of the plurality of wheels 240, and wherein the four steering actuators 262 are controllable independently of each other in their extension and retraction.

In another aspect, a power machine 200b comprises a drive chain case 290, two left wheels 240L and two right wheels 240R, a first gear box 294L and a first traction motor 292L. The two left wheels 240L and two right wheels 240R are operably connected to the drive chain case 290, wherein the two left wheels 240L and the two right wheels 240R are in contact with a ground surface that serves as a horizontal reference. The first gear box 294L is mounted on the drive chain case 290 between the two left wheels 240L. The first traction motor 292L is mounted on an upper portion of the gear box 294L and is configured to drive the two left wheels 240L.

In an exemplary embodiment, the first traction motor 292L is positioned higher than the two left wheels 240L. In an exemplary embodiment, the first traction motor 292L is electric. In an exemplary embodiment, the drive chain case comprises a left chain assembly 298, 300, 302, 304 operably connected to the two left wheels 240L and a right chain assembly 298, 300, 302, 304 operably connected to the two right wheels 240R. In an exemplary embodiment, a second traction motor 292R configured to drive the two right wheels 240R. In an exemplary embodiment, the first traction motor 292L is operable to drive the two left wheels 240L in a first direction while the second traction motor 292R is operable to drive the two right wheels 240R in a second direction that is opposite the first direction.

In yet another aspect, a power machine 200b comprises a drive chain case 290, two left wheels 240L and two right wheels 240R, a first traction motor 292L, a first gear reduction 294L and a second gear reduction (in hub 248b). The two left wheels 240L and the two right wheels 240R are operably connected to the drive chain case 290, wherein the two left wheels 240L and the two right wheels 240R are in contact with a ground surface that serves as a horizontal reference. The first traction motor 292L is configured to drive the two left wheels 240L. The first gear reduction 292L is configured to reduce a rotational speed of the first traction motor 292L to a drive chain case speed, wherein the first gear reduction 294L is disposed between the first traction motor 292L and the drive chain case 290. The second gear reduction is configured to reduce the drive chain case speed, wherein the second gear reduction is disposed between drive chain case 290 and one of the two left wheels 240L.

In an exemplary embodiment, the first gear reduction is located in a box 294L that is positioned between the two left wheels 240L. In an exemplary embodiment, the first traction motor 292L is positioned on an upper portion of the box 294L and above a top of each of the two left wheels 240L. In an exemplary embodiment, the second gear reduction is located on a hub 248b to which the one of the two left wheels 240L is mounted. In an exemplary embodiment, the hub 248b comprises a third gear reduction. In an exemplary embodiment, the hub 248b comprises a drop shaft 326 connecting the second gear reduction and the third gear reduction.

Although the subject of this disclosure has been described with reference to several embodiments, workers skilled in the art will recognize that changes may be made in form and detail without departing from the scope of the disclosure. In addition, any feature disclosed with respect to one embodiment may be included in another embodiment, and vice-versa. All references mentioned in this disclosure are hereby incorporated by reference.

1. A power machine comprising:
a frame;
a plurality of wheels in contact with a ground surface that serves as a horizontal reference;
a steering actuator mounted on the frame and configured for substantially vertical extension and retraction;
a hub comprising a stationary portion and a rotatable portion, wherein one of the plurality of wheels is mounted on the rotatable portion to pivot about a first axis with respect to the stationary portion;
a link having a first end pivotally connected to the rotatable portion of the hub; and
a bell crank comprising first, second and third pivot joints, wherein:
the first pivot joint of the bell crank is attached to an end of the steering actuator;
the second pivot joint of the bell crank is attached to the stationary portion of the hub; and
the third pivot joint of the bell crank is attached to a second end of the link.

2. The power machine of claim 1, wherein the link is configured to move substantially horizontally as the end of the steering actuator moves substantially vertically.

3. The power machine of claim 1, wherein the hub comprises a gear reduction.

4. The power machine of claim 1 comprising a connection tab by which the first end of the link is pivotally connected to the rotatable portion of the hub.

5. The power machine of claim 1, wherein the frame comprises left and right side walls, and wherein the steering actuator and link are positioned entirely outside the left and right side walls.

6. The power machine of claim 1, wherein the frame comprises a drive chain case.

7. The power machine of claim 6, wherein an axle corresponding to the one of the plurality of wheels extends from the drive chain case into the hub, and wherein a wheel axis of the one of the plurality of wheels is vertically displaced from the axle.

8. The power machine of claim 1, wherein the steering actuator is one of four steering actuators, wherein each of the four steering actuators corresponds to one of the plurality of wheels, and wherein the four steering actuators are controllable independently of each other in their extension and retraction.

9. A power machine comprising:
a drive chain case;
two left wheels and two right wheels operably connected to the drive chain case, wherein the two left wheels and the two right wheels are in contact with a ground surface that serves as a horizontal reference;
a first gear box mounted on the drive chain case between the two left wheels; and
a first traction motor mounted on an upper portion of the gear box and configured to drive the two left wheels.

10. The power machine of claim 9, wherein the first traction motor is positioned higher than the two left wheels.

11. The power machine of claim 9, wherein the first traction motor is electric.

12. The power machine of claim 9 wherein the drive chain case comprises a left chain assembly operably connected to the two left wheels and a right chain assembly operably connected to the two right wheels.

13. The power machine of claim 12, comprising a second traction motor configured to drive the two right wheels.

14. The power machine of claim 13, wherein the first traction motor is operable to drive the two left wheels in a first direction while the second traction motor is operable to drive the two right wheels in a second direction that is opposite the first direction.

15. A power machine comprising:
a drive chain case;
two left wheels and two right wheels operably connected to the drive chain case, wherein the two left wheels and the two right wheels are in contact with a ground surface that serves as a horizontal reference;
a first traction motor configured to drive the two left wheels;
a first gear reduction configured to reduce a rotational speed of the first traction motor to a drive chain case speed, wherein the first gear reduction is disposed between the first traction motor and the drive chain case; and
a second gear reduction configured to reduce the drive chain case speed, wherein the second gear reduction is disposed between drive chain case and one of the two left wheels.

16. The power machine of claim 15, wherein the first gear reduction is located in a box that is positioned between the two left wheels.

17. The power machine of claim 16, wherein the first traction motor is positioned on an upper portion of the box and above a top of the two left wheels.

18. The power machine of claim 15, wherein the second gear reduction is located on a hub to which the one of the two left wheels is mounted.

19. The power machine of claim 18, wherein the hub comprises a third gear reduction.

20. The power machine of claim 19, wherein the hub comprises a drop shaft connecting the second gear reduction and the third gear reduction.
